(19) United States
(12) Patent Application Publication
(10) Pub. No.: US 2020/0097166 A1
(43) Pub. Date: Mar. 26, 2020

(54) INFORMATION PROCESSING SYSTEM AND NON-TRANSITORY COMPUTER READABLE MEDIUM

(71) Applicant: FUJI XEROX CO.,LTD., Tokyo (JP)

(72) Inventor: Kentaro TAKANO, Kanagawa (JP)

(73) Assignee: FUJI XEROX CO.,LTD., Tokyo (JP)

(21) Appl. No.: 16/262,964

(22) Filed: Jan. 31, 2019

(30) Foreign Application Priority Data
Sep. 26, 2018 (JP) 2018-180479

(51) Int. Cl. G06F 3/0488; G06F 3/0354; G06F 3/041

(52) U.S. Cl. CPC G06F 3/04883; G06F 3/04886; G06F 3/0416; G06F 3/03545

(57) ABSTRACT

An information processing system includes an event detecting section, a switching section, and a changing section. The event detecting section detects an event influencing an angle of a writing instrument used in input of information to a terminal apparatus. The switching section switches a process performed by the terminal apparatus. The process is switched in accordance with whether or not the angle of the writing instrument exceeds a predetermined reference. The changing section changes the reference in accordance with the detection result from the event detecting section.

### CROSS-REFERENCE TO RELATED APPLICATIONS

This application is based on and claims priority under 35 USC 119 from Japanese Patent Application No. 2018-180479 filed Sep. 26, 2018.

### BACKGROUND

### (i) Technical Field

The present disclosure relates to an information processing system and a non-transitory computer readable medium.

### (ii) Related Art

Japanese Unexamined Patent Application Publication No. 2011-232806 discloses a process of selecting the operation mode of the terminal body in accordance with the state in which an input pen is operated and which is detected by a detector.

Japanese Unexamined Patent Application Publication No. 2017-41093 discloses a process of obtaining the angle of an input receiving surface with respect to the horizontal plane, and disabling touch input on a touch pad on the basis of the state in which the angle of the input receiving surface with respect to the horizontal plane is equal to or less than a predetermined threshold.

Japanese Unexamined Patent Application Publication No. 2011-159091 discloses a configuration including an axis rotation detecting unit that detects the rotation around the axis of a touch pen, and an inclination detecting unit that detects the inclination of the touch pen with respect to the planer portion.

The process performed by a terminal apparatus may be switched in accordance with whether or not the angle of a writing instrument used in input of information to the terminal apparatus exceeds a predetermined reference.

The angle of the writing instrument is changed due to various factors regardless of an operator' intention. The angle of the writing instrument may exceed the predetermined reference in spite of the fact that the operator is unlikely to intend to change the angle of the writing instrument. Thus, the process may be switched in spite of the fact that the operator is unlikely to intend to switch the process.

### SUMMARY

Aspects of non-limiting embodiments of the present disclosure relate to suppression of invocation of a process which an operator does not intend to perform, compared with the case in which a reference used to determine whether or not the process is to be switched is not changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an event detecting section, a switching section, and a changing section. The event detecting section detects an event influencing an angle of a writing instrument used in input of information to a terminal apparatus. The switching section switches a process performed by the terminal apparatus. The process is switched in accordance with whether or not the angle of the writing instrument exceeds a predetermined reference. The changing section changes the reference in accordance with the detection result from the event detecting section.

### BRIEF DESCRIPTION OF THE DRAWINGS

Exemplary embodiment of the present disclosure will be described in detail based on the following figures, wherein:

FIG. 1 is a diagram illustrating the configuration of an information processing system;

FIG. 2 is a diagram illustrating an exemplary hardware configuration of a terminal apparatus;

FIG. 3 is a diagram illustrating functional units implemented, for example, by a CPU of a terminal apparatus;

FIG. 4 is a diagram illustrating the hardware configuration of a writing instrument;

FIGS. 5A and 5B are diagrams for describing the flow of a process performed by an information processing system;

FIGS. 6A and 6B are views obtained when a terminal apparatus and a writing instrument are viewed from the direction indicated by arrow VI in FIG. 1;

FIGS. 7A and 7B are diagrams for describing the flow of another process performed by a terminal apparatus; and

FIGS. 8A to 8C are diagrams for describing the flow of another process performed by a terminal apparatus.

### DETAILED DESCRIPTION

Referring to the attached drawings, an exemplary embodiment of the present disclosure will be described below.

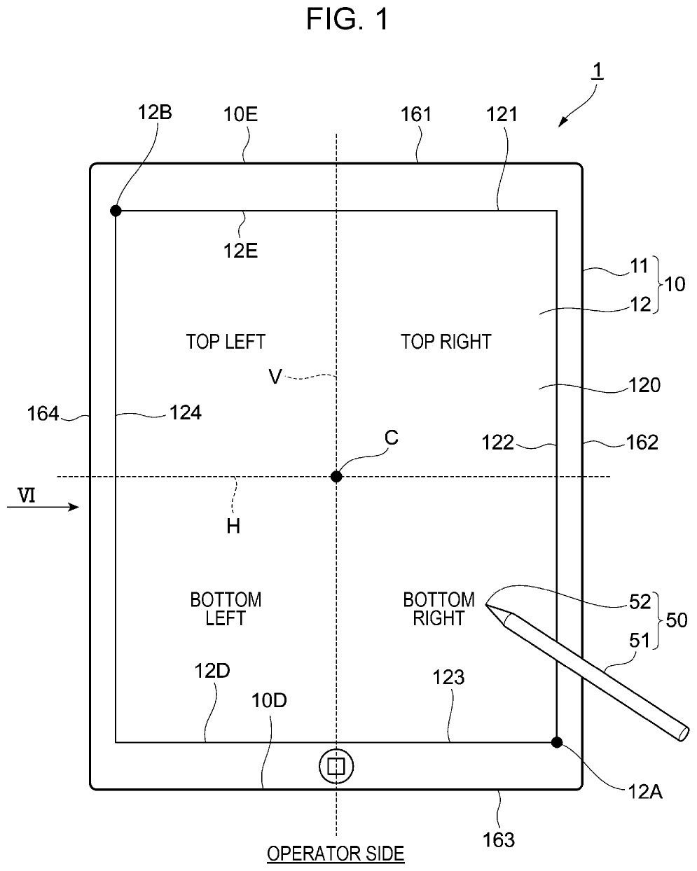

FIG. 1 is a diagram illustrating the configuration of an information processing system 1 according to the present exemplary embodiment.

The information processing system 1 according to the present exemplary embodiment includes a terminal apparatus 10 and a writing instrument 50 which is used to input information to the terminal apparatus 10.

The terminal apparatus 10 includes a terminal apparatus body 11 and a display apparatus 12 displaying information. The display apparatus 12 includes a rectangular display screen 120.

The writing instrument 50 includes a cylindrical writing instrument body 51 and a writing instrument tip 52. The writing instrument body 51 is held by an operator. The writing instrument body 51 is tipped with the writing instrument tip 52.

The terminal apparatus 10 is connected to the writing instrument 50 in a wired or wireless manner. When the terminal apparatus 10 is connected to the writing instrument 50 in a wireless manner, a known system such as Bluetooth(registered trademark) is used for the connection.

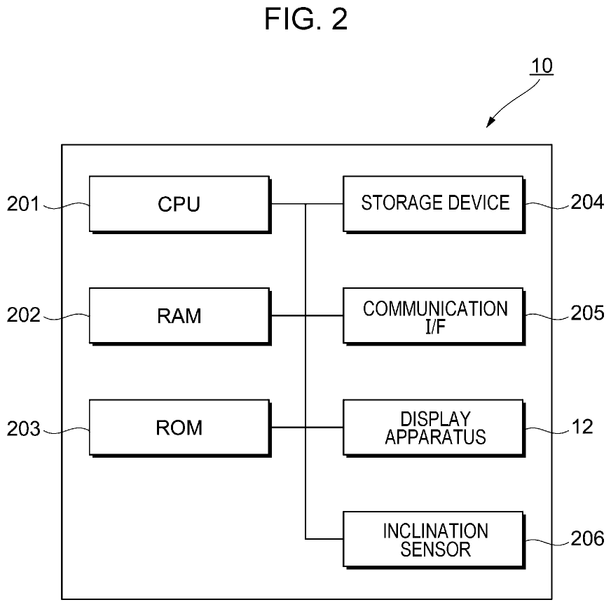

FIG. 2 is a diagram illustrating an exemplary hardware configuration of the terminal apparatus 10.

As illustrated in FIG. 2, the terminal apparatus 10 includes a central processing unit (CPU) 201, a random access memory (RAM) 202, and a read only memory (ROM) 203. The terminal apparatus 10 includes a storage device 204 which is constituted, for example, by a hard disk device and a flash memory and which stores information.

The terminal apparatus 10 further includes a communication interface (communication I/F) 205 for communicating with external apparatuses and the like, and the display apparatus 12 which displays information. The display apparatus 12 includes, for example, a touch panel display.

The terminal apparatus 10 also includes an inclination sensor 206 which detects the inclination of the terminal apparatus 10. The inclination sensor 206 is formed of a known inclination sensor. Specifically, the inclination sensor 206 is formed, for example, of an acceleration sensor or a gyroscope. The inclination sensor 206 detects the inclination of the terminal apparatus 10 with respect to the horizontal direction.

Programs executed by the CPU 201 may be provided to the terminal apparatus 10 by storing the programs in a computer-readable recording medium, such as a magnetic recording medium (for example, a magnetic tape or a magnetic disk), an optical recording medium (for example, an optical disk), a magneto-optical recording medium, or a semiconductor memory. Alternatively, the programs executed by the CPU 201 may be downloaded to the terminal apparatus 10 by using a communication unit such as the Internet.

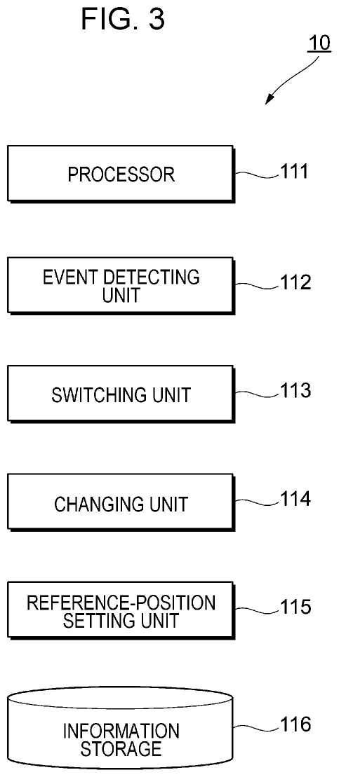

FIG. 3 is a diagram illustrating functional units implemented, for example, by the CPU 201 of the terminal apparatus 10.

As illustrated in FIG. 3, the terminal apparatus 10 includes a processor 111, an event detecting unit 112, a switching unit 113, a changing unit 114, a reference-position setting unit 115, and an information storage 116.

The processor 111, the event detecting unit 112, the switching unit 113, the changing unit 114, and the reference-position setting unit 115 are implemented, for example, by the CPU 201 executing programs stored in the ROM 203 or the storage device 204. The information storage 116 is implemented, for example, by using the storage device 204.

The processor 111 performs predetermined processes such as a display process on the display apparatus 12, for example, according to instructions from an operator.

The event detecting unit 112 serving as an exemplary event detecting section detects an event influencing the angle of the writing instrument 50 used in input of information to the terminal apparatus 10.

As described below, for example, the event detecting unit 112 detects the inclination (the inclination with respect to the horizontal direction) of the terminal apparatus 10, as an event influencing the angle of the writing instrument 50. Specifically, the event detecting unit 112 obtains the output from the inclination sensor 206, and detects the inclination of the terminal apparatus 10.

In addition, for example, the event detecting unit 112 detects the contact position, at which the writing instrument 50 is in contact with the terminal apparatus 10, as an event influencing the angle of the writing instrument 50. More specifically, the event detecting unit 112 obtains the output from the display apparatus 12 including a touch panel, and thus detects the contact position of the writing instrument 50 on the terminal apparatus 10.

In addition, for example, the event detecting unit 112 detects whether an operator's hand used to operate the writing instrument 50 is their right hand or their left hand, as an event influencing the angle of the writing instrument 50.

The switching unit 113 which serves as an exemplary switching section switches the process, which is performed by the terminal apparatus 10, in accordance with whether or not the angle of the writing instrument 50 exceeds a predetermined reference (reference angle).

In other words, the switching unit 113 switches the process, which is performed by the processor 111, in accordance with whether or not the angle of the writing instrument 50 exceeds the reference angle.

The reference (reference angle) is set as an angle with respect to the horizontal direction.

In the present exemplary embodiment, the case in which the reference (reference angle) is set as an angle with respect to the horizontal direction will be described. The reference (reference angle) may be set as an angle with respect to the terminal apparatus 10. More specifically, the reference (reference angle) may be set, for example, as an angle with respect to the surface of the terminal apparatus 10 (the surface on the display screen 120 side).

The changing unit 114 which serves as an exemplary changing section changes the reference (reference angle) in accordance with the detection result from the event detecting unit 112.

The reference-position setting unit 115 sets the reference position described below.

The information storage 116 stores various types of information such as a threshold table described below.

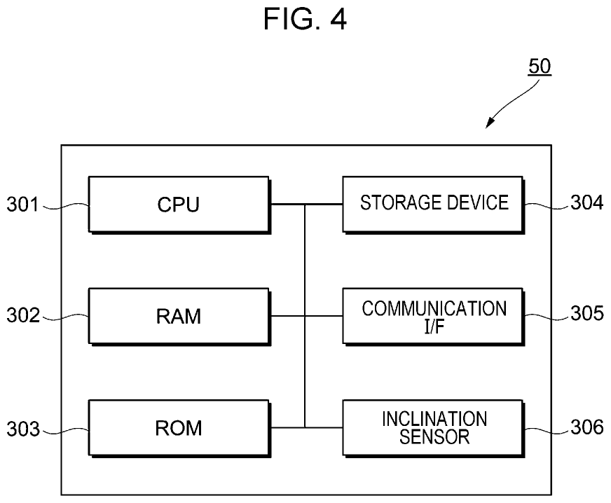

FIG. 4 is a diagram illustrating the hardware configuration of the writing instrument 50.

As illustrated in FIG. 4, the writing instrument 50 includes a CPU 301, a RAM 302, and a ROM 303. The writing instrument 50 also includes a storage device 304 which is constituted, for example, by a flash memory and which stores information.

The writing instrument 50 further includes a communication I/F 305 for communicating with the terminal apparatus 10. The writing instrument 50 also includes an inclination sensor 306 which detects the inclination of the writing instrument 50.

The inclination sensor 306 detects the inclination of the writing instrument 50 with respect to the horizontal direction. The inclination sensor 306 is formed of a known inclination sensor. Specifically, for example, the inclination sensor 306 is formed, for example, of an acceleration sensor or a gyroscope.

In the present exemplary embodiment, an operator uses the writing instrument 50 to perform writing on the display apparatus 12 (display screen 120) including a touch panel. Thus, the terminal apparatus 10 obtains the information written by the operator (the information that is input by the operator).

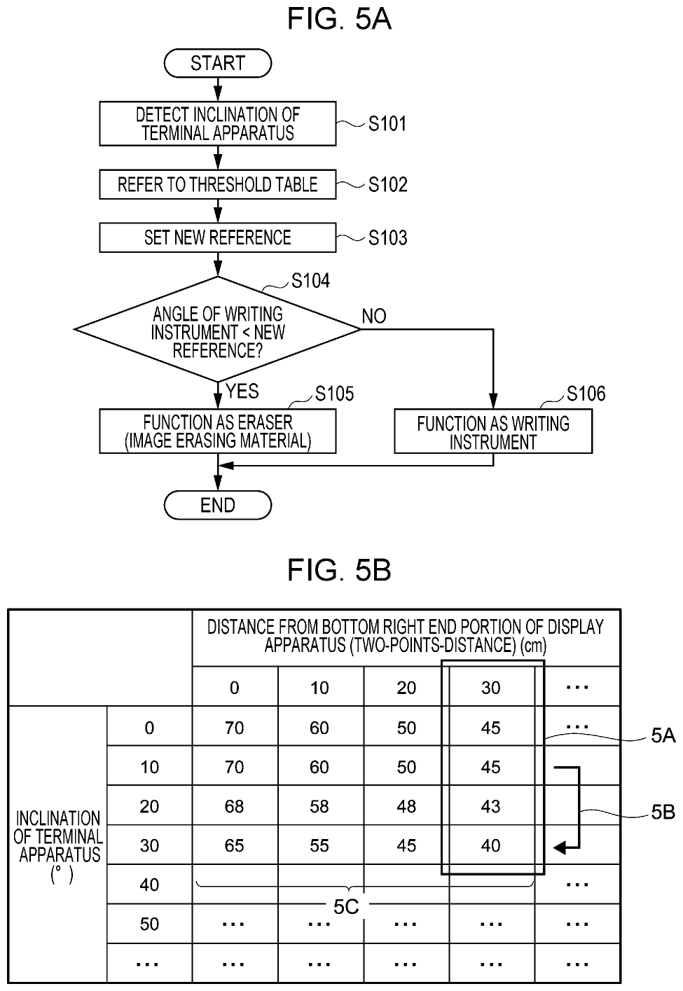

FIGS. 5A and 5B are diagrams for describing the flow of a process performed by the information processing system 1 according to the present exemplary embodiment.

In the present exemplary embodiment, as illustrated in FIG. 5A, the event detecting unit 112 receives information, which is sequentially output from the inclination sensor 206, about the inclination of the terminal apparatus 10, and detects the inclination of the terminal apparatus 10 at each predetermined timing (step S101).

In the present exemplary embodiment, when the inclination of the terminal apparatus 10 increases, the changing unit 114 changes the reference (reference angle) so that the reference comes closer to the horizontal plane (the reference angle is made smaller).

In other words, in the present exemplary embodiment, the changing unit 114 changes the reference in accordance with the inclination of the terminal apparatus 10. If the inclination of the terminal apparatus 10 increases, the changing unit 114 changes the reference so that the reference comes closer to the horizontal plane.

More specifically, in the present exemplary embodiment, the information storage 116 stores a threshold table illustrated in FIG. 5B.

Every time the event detecting unit 112 detects the inclination of the terminal apparatus 10, the changing unit 114 refers to the fields, which are indicated by the reference character 5A, in the threshold table (step S102), obtains a reference, and sets the obtained reference as a new reference (step S103).

Specifically, for example, when the event detecting unit 112 detects that the inclination of the terminal apparatus 10 is 30°, the changing unit 114 refers to the threshold table, obtains a reference, 40°, and sets the obtained reference, 40°, as a new reference.

In the present exemplary embodiment, as indicated by the reference character 5B, for example, when the inclination of the terminal apparatus 10 changes from 10° to 30°, the changing unit 114 sets a new reference, and the reference is changed from 45° to 40°.

In other words, in the present exemplary embodiment, when the inclination of the terminal apparatus 10 increases, the reference is changed so as to come closer to the horizontal plane. Put another way, when the inclination of the terminal apparatus 10 increases, the reference angle is changed so as to be made smaller.

In other words, in the present exemplary embodiment, when the inclination of the terminal apparatus 10 increases, the reference is changed so that the switching unit 113 is made difficult to switch the process compared with the previous state before the inclination increases.

More specifically, when the inclination of the terminal apparatus 10 increases, the reference is changed so that, even if the writing instrument 50 is inclined at the same angle as the angle of the writing instrument 50 obtained before the inclination of the terminal apparatus 10 increases, the switching unit 113 is made difficult to switch the process.

After that, the switching unit 113 determines whether or not the angle of the writing instrument 50 is smaller than the newly set reference (step S104).

The switching unit 113 switches the process, which is performed by the terminal apparatus 10, in accordance with whether or not the angle of the writing instrument 50 is smaller than the new reference.

In other words, the switching unit 113 switches the process, which is performed by the processor 111, in accordance with whether or not the angle of the writing instrument 50 exceeds the new reference.

Specifically, in the present exemplary embodiment, in step S104, if it is determined that the angle of the writing instrument 50 is smaller than the newly set reference, the switching unit 113 causes the writing instrument 50 to function as an eraser (image erasing material) (step S105).

In other words, if the angle of the writing instrument 50 is smaller than the newly set reference, the switching unit 113 causes the processor 111 to perform a process of erasing an image which is displayed on the display apparatus 12 and which is located at the position at which the writing instrument 50 is in contact with the display apparatus 12.

If the angle of the writing instrument 50 is equal to or larger than the newly set reference, the switching unit 113 causes the writing instrument 50 to function as a writing instrument (step S106).

In other words, if the angle of the writing instrument 50 is equal to or larger than the newly set reference, the switching unit 113 causes the processor 111 to perform a process of displaying an image at a position, at which the writing instrument 50 is in contact with the display apparatus 12, on the display apparatus 12.

In the present exemplary embodiment, the process performed by the terminal apparatus 10 is switched in accordance with the angle of the writing instrument 50. Thus, a single writing instrument 50 may function as an image erasing material and a writing instrument as described above.

The angle of the writing instrument 50 changes due to various factors regardless of an operator's intention. In this case, the angle of the writing instrument 50 sometimes crosses the reference in spite of the fact that an operator is unlikely to intend to change the angle of the writing instrument 50, and the process is switched in spite of the fact that the operator is unlikely to intend to switch the process.

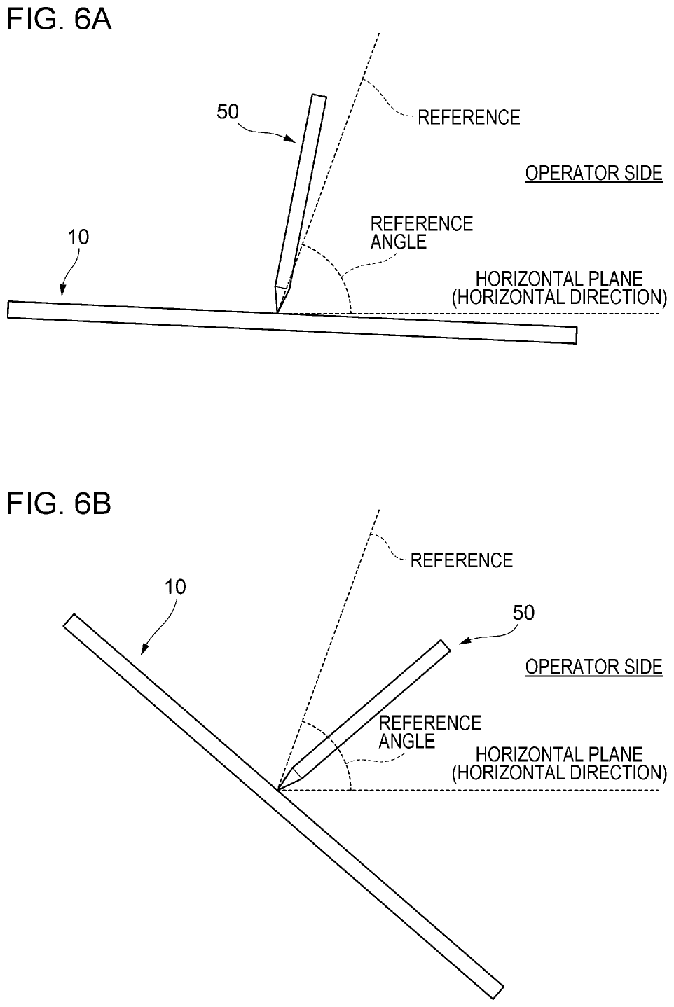

Specifically, for example, as illustrated in FIGS. 6A and 6B (views obtained when the terminal apparatus 10 and the writing instrument 50 are viewed from the direction indicated by arrow VI in FIG. 1), when the inclination of the terminal apparatus 10 is changed from small to large, the angle of the writing instrument 50 is made small in spite of the fact that an operator is unlikely to intend to change the angle of the writing instrument 50.

In this case, the angle of the writing instrument 50 crosses the reference (is made smaller than the reference), and the process is switched in spite of the fact that an operator is unlikely to change the angle of the writing instrument 50 with an intention to switch the process.

Accordingly, in the present exemplary embodiment, as described above, the reference is changed in accordance with the inclination of the terminal apparatus 10. Specifically, when the inclination of the terminal apparatus 10 increases, the reference is changed so as to come closer to the horizontal plane.

Thus, even when the angle of the writing instrument 50 is made small, for example, due to the inclination of the terminal apparatus 10, the angle of the writing instrument 50 is made difficult to cross the reference, suppressing invocation of a process which an operator does not intend to perform.

In the above description, the case in which the writing instrument 50 has functions of an image erasing material and a writing instrument and in which the function of the writing instrument 50 is switched between the function of an image erasing material and the function of a writing instrument in accordance with whether or not the angle of the writing instrument 50 exceeds the reference is taken as an example.

This is merely an example. The processes before and after the process switching may be other processes.

For example, when the angle of the writing instrument 50 is made smaller than the reference, the writing instrument 50 may enter the sleep state (the state in which power supply is stopped). When the angle of the writing instrument 50 is equal to or larger than the reference, the writing instrument 50 may function as a writing instrument.

Alternatively, for example, the type (the color, the thickness, and the style) of a line formed by the writing instrument 50 may be changed in accordance with whether or not the angle of the writing instrument 50 exceeds the reference.

In the threshold table according to the present exemplary embodiment, as illustrated in FIG. 5B, the distance from the end portion (corner portion) 12A (see FIG. 1) located at the bottom right of the display screen 120, as well as the inclination of the terminal apparatus 10, is also stored as a parameter for obtaining a new reference.

Specifically, information about the distance (hereinafter referred to as the “two-points-distance”) between the contact position of the writing instrument 50 on the display screen 120 and the end portion 12A, as well as the inclination of the terminal apparatus 10, is also stored as a parameter for obtaining a new reference.

Therefore, in the present exemplary embodiment, a new reference may be obtained on the basis of both the inclination of the terminal apparatus 10 and the two-points-distance. In other words, a new reference may be obtained on the basis of the two parameters.

Specifically, for example, in the case where the inclination of the terminal apparatus 10 is 30° and where the two-points-distance is 10 cm, 55° is obtained as a new reference.

For example, in the case where the inclination of the terminal apparatus 10 is 30° and where the two-points-distance is 30 cm, 40° is obtained as a new reference.

In the threshold table, the longer the two-points-distance is, the smaller the reference is. The reason why, as the two-points-distance increases, the reference is made smaller will be described below.

Thus, when both the inclination of the terminal apparatus 10 and the two-points-distance are capable of being obtained, the two parameters may be used to obtain a new reference.

In contrast, when the two-points-distance fails to be obtained, or when the two-points-distance is purposely not used, as described in steps S101 to S103, a new reference may be obtained on the basis of only the angle of the terminal apparatus 10.

When a new reference is to be obtained by using the threshold table on the basis of only the angle of the terminal apparatus 10, multiple reference candidates are present.

Specifically, for example, when the angle of the terminal apparatus 10 is 30°, there are multiple reference candidates, such as 65°, 55°, 45°, and 40° indicated by the reference character 5C.

In the processes described in steps S101 to S103 according to the present exemplary embodiment, the description is made by taking, as an example, the case in which the smallest value, 40°, among the multiple candidates is set as a new reference.

In other words, in the present exemplary embodiment, a reference is obtained from the fields indicated by the reference character 5A. The references in the fields indicated by the reference character 5A are the smallest references, each of which is among the references for the corresponding angle of the terminal apparatus 10.

In the processes described in steps S101 to S103, the smallest reference is obtained among the multiple candidates, and the smallest reference is set as a new reference.

Thus, when the smallest reference is set as a new reference, compared with the case in which a large reference is set as a new reference, the process will be switched only when the writing instrument 50 is inclined to a large degree. Therefore, it is more difficult to perform a process which an operator does not intend to perform.

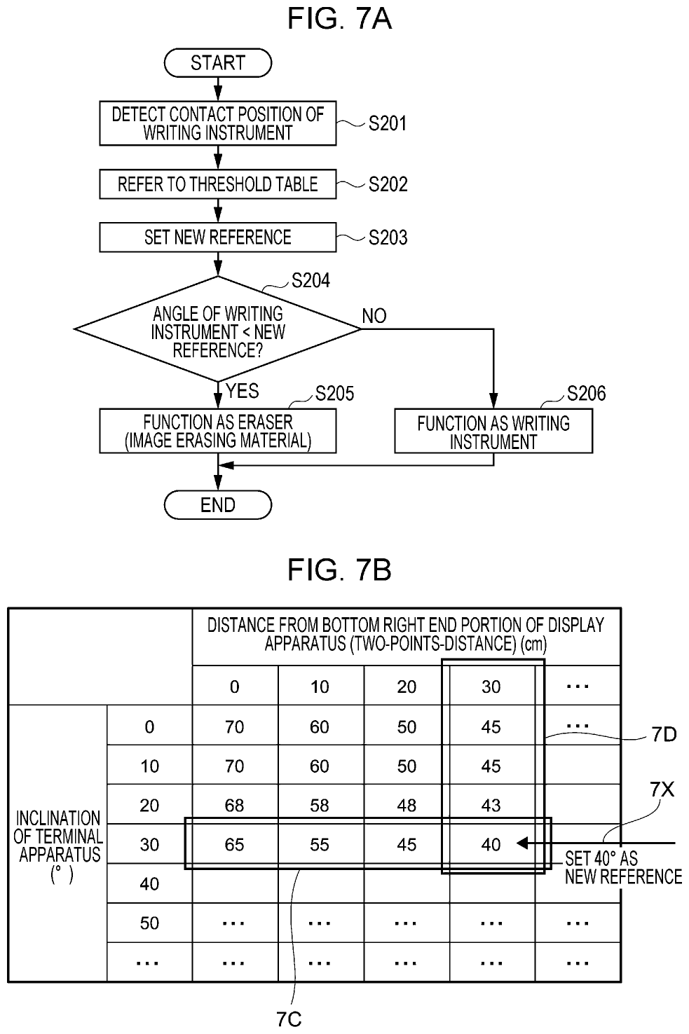

FIGS. 7A and 7B are diagrams for describing the flow of another process performed by the terminal apparatus 10.

As illustrated in FIG. 7A, in this exemplary process, the event detecting unit 112 detects the contact position of the writing instrument 50 on the terminal apparatus 10 (step S201).

In other words, the event detecting unit 112 detects the contact position of the writing instrument 50 on the terminal apparatus 10, as an event influencing the angle of the writing instrument 50.

Specifically, the event detecting unit 112 detects the contact position (the contact position on the display screen 120) at which the writing instrument tip 52 (see FIG. 1) of the writing instrument 50 is in contact with the display screen 120, on the basis of the output from the display apparatus 12 including a touch panel.

The changing unit 114 refers to the threshold table (step S202).

The changing unit 114 obtains a new reference from the threshold table on the basis of information stored in the threshold table and the contact position detected in step S201, and sets the obtained reference as a new reference (step S203).

More specifically, in the present exemplary embodiment, the end portion (corner portion) 12A (see FIG. 1) located at the bottom right of the display screen 120 is preset as the reference position.

In setting a new reference, the changing unit 114 obtains the distance (two-points-distance) between the contact position detected by the event detecting unit 112 and the reference position (end portion 12A).

Then, the changing unit 114 refers to the threshold table (see FIG. 7B). The changing unit 114 obtains a new reference on the basis of information stored in the threshold table and the two-points-distance, and sets the obtained reference as a new reference.

Specifically, for example, when the two-points-distance is 30 cm, the changing unit 114 obtains a reference, 40°, as indicated by the reference character 7X in FIG. 7B, and sets the obtained reference, 40°, as a new reference.

In this exemplary process, the changing unit 114 refers to information in the fields indicated by the reference character 7C, obtains a new reference, and sets the reference as a new reference.

For example, when the two-points-distance is changed from 10 cm to 30 cm, the changing unit 114 obtains a reference, 40°, and sets the obtained reference, 40°, as a new reference. In this case, the reference is changed from 55° to 40°.

Thus, in this exemplary process, when the two-points-distance is made longer, the reference is changed so as to come closer to the horizontal plane. Put another way, when the two-points-distance is made longer, the reference angle is changed so as to be made further smaller.

When the reference (reference angle) is set as an angle with respect to the terminal apparatus 10 (when the reference (reference angle) is set as the angle between the reference and the terminal apparatus 10), the reference is changed so as to come close to the terminal apparatus 10.

After that, similarly to the process described above, when an operator performs a writing operation, the switching unit 113 determines whether or not the angle of the writing instrument 50 is smaller than the new reference which has been set (step S204).

If the angle of the writing instrument 50 is smaller than the new reference which has been set, the switching unit 113 causes the writing instrument 50 to function as an eraser (image erasing material) (step S205).

If the angle of the writing instrument 50 is equal to or larger than the new reference, the switching unit 113 causes the writing instrument 50 to continue to function as a writing instrument (step S206).

Thus, in this exemplary process, the changing unit 114 changes the reference in accordance with the contact position of the writing instrument 50. More specifically, the changing unit 114 changes the reference in accordance with the contact position with respect to the preset reference position.

More specifically, in this exemplary process, the reference position is located in the end portion 12A of the display screen 120. When the distance from the end portion 12A to the contact position is made longer, the changing unit 114 changes the reference so that the reference comes closer to the horizontal plane.

As an event influencing the angle of the writing instrument 50, the contact position of the writing instrument 50 on the terminal apparatus 10 is used in addition to the angle of the terminal apparatus 10.

Specifically, in the case where an operator operates the writing instrument 50 with their right hand, as the contact position (writing position) is located further away from the end portion 12A of the display screen 120, the angle of the writing instrument 50 is easily made smaller.

In other words, as the contact position comes closer to the end portion 12B (corner portion) (see FIG. 1) located at the top left of the display screen 120, the writing instrument 50 tends to approach the lying position. As the contact position comes closer to the end portion 12B, the angle of the writing instrument 50 is easily made small.

Put another way, as the contact position is located further away from the operator's body, the angle of the writing instrument 50 is easily made small.

In this case, similarly to the case described above, the angle of the writing instrument 50 crosses the predetermined reference in spite of the fact that an operator is unlikely to intend to change the angle of the writing instrument 50. The process may be switched in spite of the fact that the operator is unlikely to intend to switch the process.

In contrast, if the reference is changed in accordance with the writing position as in the present exemplary embodiment, unintended switching of the process is difficult to occur.

The description is made by taking, as an example, the case in which the bottom right of the terminal apparatus 10 is set as the reference position. The reference position is not limited to the bottom right of the terminal apparatus 10.

For example, the lower end 12D (see FIG. 1) of the display screen 120 or the lower end 10D (see FIG. 1) of the terminal apparatus 10 may be set as a reference.

The lower end of the display screen 120 indicates a portion in which the outer edge 123 positioned on the operator side among the four outer edges 121 to 124 of the display screen 120 is located. The lower end of the terminal apparatus 10 indicates a portion in which the outer edge 163 positioned on the operator side among the four outer edges 161 to 164 of the terminal apparatus 10 is located.

In the case where the lower end 12D of the display screen 120 or the lower end 10D of the terminal apparatus 10 is set as the reference position, when the distance between the contact position and the lower end 12D of the display apparatus 12 or the lower end 10D of the terminal apparatus 10 increases, the changing unit 114 changes the reference so as to come closer to the horizontal plane.

Alternatively, the top end 12E of the display screen 120 or the top end 10E of the terminal apparatus 10 may be set as the reference position. In this case, when the contact position comes close to the top end 12E of the display screen 120 or the top end 10E of the terminal apparatus 10, the changing unit 114 changes the reference so as to come closer to the horizontal plane.

The top end 12E of the display screen 120 indicates a portion in which the outer edge 121, which is positioned on the opposite side to the outer edge positioned on the operator side, among the four outer edges 121 to 124 of the display apparatus 12 is located.

The top end 10E of the terminal apparatus 10 indicates a portion in which the outer edge 161, which is positioned on the opposite side to the outer edge 163 positioned on the operator side, among the four outer edges 161 to 164 of the terminal apparatus 10 is located.

The reference position is not limited to a fixed position. For example, the reference position may be changed in accordance with whether an operator's hand used to operate the writing instrument 50 is their right hand or their left hand.

Specifically, for example, when an operator's right hand is used to operate the writing instrument 50, the reference position may be set in the bottom right portion of the display screen 120. When an operator's left hand is used to operate the writing instrument 50, the reference position may be set in the bottom left portion of the display screen 120.

The reference position is set by the reference-position setting unit 115 (see FIG. 3). A method of detecting whether an operator's hand used to operate the writing instrument 50 is their right hand or their left hand will be described below.

For example, when an operator's right hand is used to operate the writing instrument 50, the reference position may be set to any position on the right half side of the display screen 120. When an operator's left hand is used to operate the writing instrument 50, the reference position may be set to any position on the left half side of the display screen 120.

Herein, the bottom right portion of the display screen 120 indicates an area which is located lower than the horizontal line H (a line along the outer edge 121 on the upper side of the display screen 120 and the outer edge 123 on the lower side of the display screen 120) passing through the center portion C (see FIG. 1) of the display screen 120 and which is located on the right of the vertical line V (a line along the outer edge 122 on the right side of the display screen 120 and the outer edge 124 on the left side of the display screen 120) passing through the center portion C.

The bottom left portion of the display screen 120 indicates an area which is located on the lower side of the horizontal line H and which is located on the left side of the vertical line V.

The right half of the display screen 120 indicates an area located on the right side of the vertical line V.

The left half of the display screen 120 indicates an area located on the left side of the vertical line V.

The reference may be changed on the basis of the absolute position of the contact position.

Specifically, for example, when the contact position is located in the top right portion or the top left portion of the display screen 120, the reference may be made to come closer to the horizontal plane than the case in which the contact position is located in the bottom right portion or the bottom left portion of the display screen 120.

Alternatively, for example, when the contact position is located on the upper side of the display screen 120, the reference may be made to come closer to the horizontal plane than the case in which the contact position is located on the lower side of the display screen 120.

The upper side indicates an area located on the upper side of the horizontal line H in the display screen 120. The lower side indicates an area located on the lower side of the horizontal line H in the display screen 120.

As illustrated in FIG. 7B, also in this exemplary process, the threshold table stores inclinations of the terminal apparatus 10 and two-points-distances as parameters used to obtain a new reference.

Therefore, also in this process, a new reference may be obtained on the basis of the inclination of the terminal apparatus 10 and the two-points-distance.

Specifically, also in this example, for example, in the case where the inclination of the terminal apparatus 10 is 30° and where the two-points-distance is 10 cm, 55° is obtained as a new reference.

For example, in the case where the inclination of the terminal apparatus 10 is 30° and where the two-points-distance is 30 cm, 40° is obtained as a new reference.

Also in this threshold table, the longer the two-points-distance is, the smaller the reference is.

When both the inclination of the terminal apparatus 10 and the two-points-distance are capable of being obtained, a new reference may be obtained by using these two parameters and the threshold table illustrated in FIG. 7B.

In contrast, when the angle of the terminal apparatus 10 fails to be obtained, or when the angle of the terminal apparatus 10 is purposely not used, as described in steps S201 to S203, a new reference may be obtained on the basis of only the two-points-distance.

When a new reference is obtained on the basis of only the two-points-distance by using the threshold table illustrated in FIG. 7B, similarly to the case described above, multiple reference candidates for a new reference are present.

Specifically, for example, when the two-points-distance is 30 cm, there are multiple reference candidates, such as 45°, 45°, 43°, and 40° as indicated by the reference character 7D.

The processes in steps S201 to S203 are described by taking, as an example, the case in which the smallest reference, 40°, among the multiple candidates is set as a new reference.

Thus, in the case where the smallest reference is set as a new reference, only when the writing instrument 50 is inclined to a large degree, the process is switched, making it difficult to invoke a process which an operator does not intend to perform.

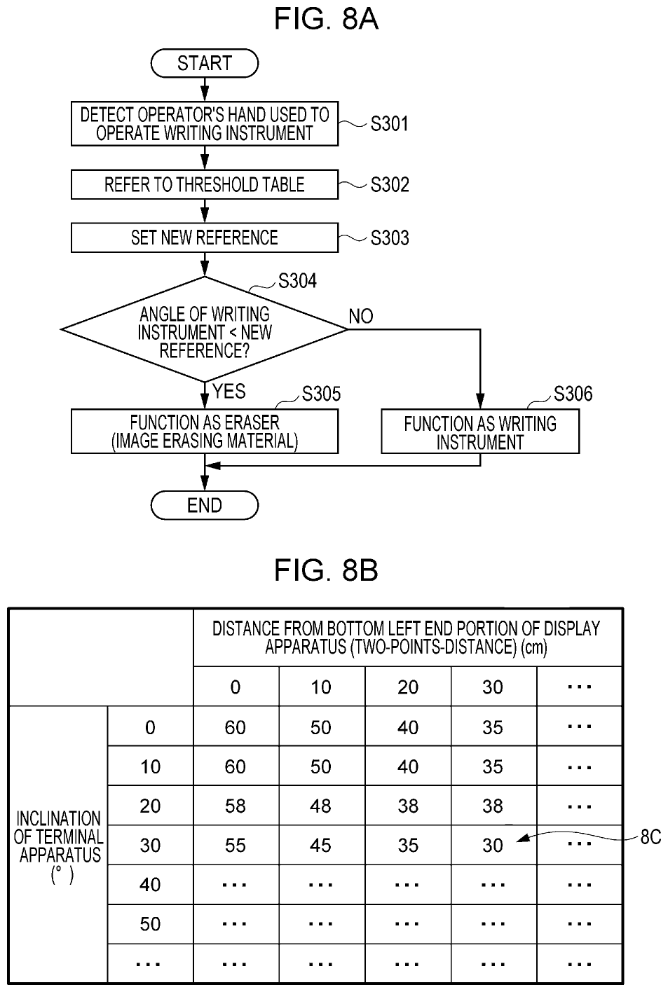

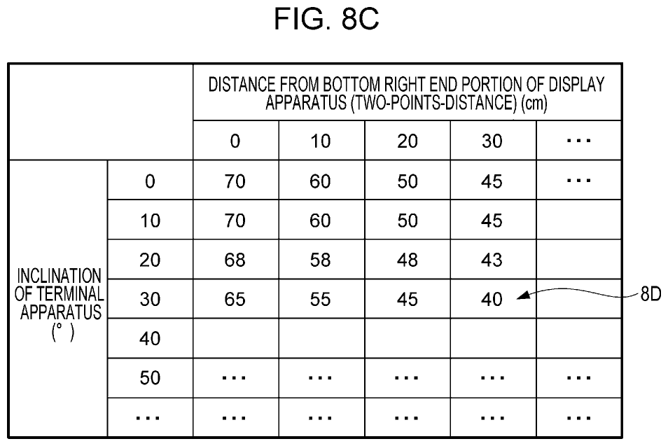

FIGS. 8A to 8C are diagrams for describing the flow of another process performed by the terminal apparatus 10.

As illustrated in FIG. 8A, in this process, the event detecting unit 112 detects an operator's hand, which is used to operate the writing instrument 50, as an event influencing the angle of the writing instrument 50 (step S301).

Specifically, the event detecting unit 112 detects whether an operator's hand used to operate the writing instrument 50 is their right hand or their left hand.

The changing unit 114 refers to the threshold table (step S302).

Similarly to the case described above, the changing unit 114 obtains a new reference on the basis of information about the operating hand detected by the event detecting unit 112 and information stored in the threshold table, and sets the obtained reference as a new reference (step S303).

Specifically, in the example, when the operator's left hand is used to operate the writing instrument 50, the changing unit 114 refers to the threshold table for left hand illustrated in FIG. 8B, obtains the reference, 30°, indicated by the reference character 8C, and sets the reference, 30°, as a new reference.

When the operator's right hand is used to operate the writing instrument 50, the changing unit 114 refers to the threshold table for right hand illustrated in FIG. 8C, obtains the reference, 40°, indicated by the reference character 8D, and sets the reference, 40°, as a new reference.

In this exemplary process, a different reference is set in accordance with whether an operator's hand used to operate the writing instrument 50 is their right hand or their left hand. The reference is changed in accordance with whether the operator's hand used to operate the writing instrument 50 is their right hand or their left hand.

Further, in this exemplary process, when an operator's left hand is used to operate the writing instrument 50, the reference is made to come closer to the horizontal plane than the case in which the operator's right hand is used to operate the writing instrument 50. In other words, when an operator's left hand is used to operate the writing instrument 50, the reference angle is made smaller than the case of their right hand.

In other words, in the present exemplary embodiment, when an operator's left hand is used to operate the writing instrument 50, the reference is changed so that switching of the process, which is performed by the switching unit 113, is made more difficult to be invoked compared with the case of their right hand.

More specifically, when an operator's left hand is used to operate the writing instrument 50, the reference is changed so that, even if the writing instrument 50 is inclined at the same angle as the angle obtained in the case where writing is performed with their right hand, switching of the process, which is performed by the switching unit 113, is difficult to invoke.

After that, the process is similar to the case described above. It is determined whether or not the inclination of the writing instrument 50 is smaller than the new reference which has been set (step S304). If the inclination is smaller than the reference, the writing instrument 50 is made to function as an eraser (image erasing material) (step S305).

If the inclination of the writing instrument 50 is equal to or larger than the new reference which has been set, the writing instrument 50 is made to function as a writing instrument (step S306).

When writing is performed with an operator's left hand, the writing instrument 50 is pushed in writing. Compared with the case in which writing is performed with their right hand, the writing instrument 50 tends to approach the lying position.

Therefore, in the present exemplary embodiment, the reference is changed in accordance with which hand is used to operate the writing instrument 50. Specifically, when an operator's left hand is used to operate the writing instrument 50, the reference is made to come closer to the horizontal plane compared with the case in which their right hand is used to operate the writing instrument 50.

Which hand is used to operate (hold) the writing instrument 50 is detected (whether an operator's hand used to operate the writing instrument 50 is their right hand or their left hand is detected), for example, on the basis of information which is input from the operator.

Specifically, for example, a screen for inputting information about whether the operator is right-handed or left-handed is displayed on the display screen 120 (see FIG. 1). On the basis of the input from the operator on the screen (on the basis of the information which has been input), the event detecting unit 112 detects which hand is used to operate the writing instrument 50.

Detection of the hand used to operate the writing instrument 50 is not limited to detection based on the information which is input from the operator, and may be automatically performed by using another known method.

Also in this exemplary process, similarly to the case described above, information about inclinations of the terminal apparatus 10 and two-points-distances is stored in the threshold table for right hand and the threshold table for left hand. Also in this exemplary process, one or both of the two parameters may be used to obtain a new reference.

A new reference may be set without use of the two parameters, the inclination of the terminal apparatus 10 and the two-points-distance. That is, a new reference may be, set on the basis of only information about an operator's hand used to operate the writing instrument 50.

In this case, among the references stored in the corresponding one of the threshold table for right hand and the threshold table for left hand, it is desirable to select the smallest reference.

In the exemplary process described in steps S301 to S303, the case in which the smallest reference, 30° (in the case of use of an operator's left hand) or 40° (in the case of use of an operator's right hand), is selected is illustrated.

Similarly to the case described above, if the smallest reference is selected, only when the writing instrument 50 is inclined to a large degree, the process is switched, making it difficult to invoke a process which an operator does not intend to perform.

In addition, the event detecting unit 112 may detect the information input mode, in which an operator inputs information to the terminal apparatus 10 by using the writing instrument 50, as an event influencing the angle of the writing instrument 50. In this case, the changing unit 114 changes the reference in accordance with the detected information input mode.

Specifically, for example, the event detecting unit 112 detects the information input mode which has been set by an operator, such as the character input mode or the illustration input mode.

In this case, for example, when the information input mode is the character input mode, the changing unit 114 makes the reference come closer to the horizontal plane compared with the case in which the information input mode is not the character input mode.

In the character input mode, it is assumed that the writing instrument 50 approaches the lying position compared with the other information input modes such as the illustration mode. In this case, it is desirable to make the reference come closer to the horizontal plane. In other words, when a picture, not characters, is input, occurrence of the state in which the writing instrument 50 approaches the lying position is suppressed compared with the case of input of characters. In contrast, when characters are input, the writing instrument 50 is easy to approach the lying position. In this case, in the character input mode, it is desirable to make the reference come closer to the horizontal plane.

Characters are written from left to right in most cases. Therefore, when characters are written with an operator's left hand, the writing instrument 50 is pushed. In the case of use of their right hand, the writing instrument 50 is pulled. In the case of pushing the writing instrument 50, compared with the case of pulling the writing instrument 50, the writing instrument 50 is used at such an angle that the writing instrument 50 comes closer to the lying position.

Further, when a picture, not characters, is input, even in the case of use of an operator's left hand, the force of pushing the writing instrument 50 weakens. Thus, compared with the case of input of characters, occurrence of the state in which the writing instrument 50 approaches the lying position is suppressed.

Therefore, in the character input mode, compared with other information input modes such as the illustration mode, it is desirable to make the reference come closer to the horizontal plane (it is desirable to make the reference small).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
an event detecting section that detects an event influencing an angle of a writing instrument used in input of information to a terminal apparatus;
a switching section that switches a process performed by the terminal apparatus, the process being switched in accordance with whether or not the angle of the writing instrument exceeds a predetermined reference; and
a changing section that changes the reference in accordance with the detection result from the event detecting section.

2. The information processing system according to claim 1,
wherein the event detecting section detects an inclination of the terminal apparatus as the event influencing the angle of the writing instrument, and
wherein the changing section changes the reference in accordance with the inclination of the terminal apparatus.

3. The information processing system according to claim 2,
wherein, when the inclination of the terminal apparatus increases, the changing section changes the reference so as to decrease the reference.

4. The information processing system according to claim 2,
wherein, when the inclination of the terminal apparatus increases, the changing section changes the reference in such a manner that it is difficult for the switching section to switch the process compared with a state before the inclination increases.

5. The information processing system according to claim 3,
wherein, when a distance between a contact position of the writing instrument on the terminal apparatus and a lower end of the terminal apparatus increases, the changing section changes the reference so as to decrease the reference.

6. The information processing system according to claim 3,
wherein, when a contact position of the writing instrument on the terminal apparatus comes close to a top end of the terminal apparatus, the changing section changes the reference so as to decrease the reference.

7. The information processing system according to claim 1,
wherein the event detecting section detects a contact position of the writing instrument on the terminal apparatus, as the event influencing the angle of the writing instrument, and
wherein the changing section changes the reference in accordance with the contact position.

8. The information processing system according to claim 7,
wherein the changing section changes the reference in accordance with the contact position with respect to a predetermined reference position.

9. The information processing system according to claim 8,
wherein the reference position is changed in accordance with whether a hand used to operate the writing instrument is a right hand or a left hand.

10. The information processing system according to claim 8,
wherein the reference position is located in a bottom right portion or a bottom left portion of a display screen provided for the terminal apparatus, and
wherein, when a distance from the reference position to the contact position increases, the changing section changes the reference so as to decrease the reference.

11. The information processing system according to claim 9,
wherein, when the hand used to operate the writing instrument is a right hand, the reference position is set in a bottom right portion of a display screen provided for the terminal apparatus, and
wherein, when the hand used to operate the writing instrument is a left hand, the reference position is set in a bottom left portion of the display screen.

12. The information processing system according to claim 7,
wherein the terminal apparatus includes a display screen, and
wherein, when the contact position is located in a top right portion or a top left portion of the display screen, the changing section changes the reference so as to decrease the reference compared with a case in which the contact position is located in a bottom right portion or a bottom left portion of the display screen.

13. The information processing system according to claim 7,
wherein the terminal apparatus includes a display screen, and
wherein, when the contact position is located on an upper side of the display screen, the changing section changes the reference so as to decrease the reference compared with a case in which the contact position is located on a lower side of the display screen.

14. The information processing system according to claim 1,
wherein the event detecting section detects whether a hand used to operate the writing instrument is a right hand or a left hand, as the event influencing the angle of the writing instrument, and
wherein the changing section changes the reference in accordance with whether a hand used to operate the writing instrument is a right hand or a left hand.

15. The information processing system according to claim 14,
wherein, when the hand used to operate the writing instrument is a left hand, the changing section changes the reference so as to decrease the reference compared with a case in which the hand used to operate the writing instrument is a right hand.

16. The information processing system according to claim 14,
wherein, when the hand used to operate the writing instrument is a left hand, the changing section changes the reference in such a manner that it is difficult for the switching section to switch the process compared with a case in which the hand used to operate the writing instrument is a right hand.

17. The information processing system according to claim 1,
wherein the event detecting section detects an information input mode as the event influencing the angle of the writing instrument, the information input mode being used when an operator inputs information to the terminal apparatus by using the writing instrument, and
wherein the changing section changes the reference in accordance with the information input mode.

18. The information processing system according to claim 17,
wherein, when the information input mode is a character input mode, the changing section changes the reference so as to decrease the reference compared with a case in which the information input mode is other than the character input mode.

19. A non-transitory computer readable medium storing a program causing a computer to execute a process comprising:
detecting an event influencing an angle of a writing instrument used in input of information to a terminal apparatus;
switching a process performed by the terminal apparatus, the process being switched in accordance with whether or not the angle of the writing instrument exceeds a predetermined reference; and
changing the reference in accordance with the detection result.

20. An information processing system comprising:
means for detecting an event influencing an angle of a writing instrument used in input of information to a terminal apparatus;
means for switching a process performed by the terminal apparatus, the process being switched in accordance with whether or not the angle of the writing instrument exceeds a predetermined reference; and
means for changing the reference in accordance with the detection result.
